(19) United States
(12) Patent Application Publication
(10) Pub. No.: US 2021/0117837 A1
(43) Pub. Date: Apr. 22, 2021

(54) SECURE INTELLIGENT NETWORKED ARCHITECTURE WITH DYNAMIC FEEDBACK

(71) Applicant: Fintex Holdings, Inc., Houston, TX (US)

(72) Inventors: Michael Nelskyla, Houston, TX (US); Adam Watts, Pearland, TX (US)

(21) Appl. No.: 16/655,003

(22) Filed: Oct. 16, 2019

(51) Int. Cl. G06N 7/00; H04L 29/06; G06Q 40/02; G06Q 30/02

(52) U.S. Cl. CPC G06N 7/005; G06Q 30/0203; G06Q 40/025; H04L 63/102

(57) ABSTRACT

Provided herein are exemplary systems and methods for a secure intelligent networked architecture with dynamic feedback. Exemplary methods for automatically adapting a volatility target to a current user's preference includes an intelligent probabilistic volatility server receiving from an interactive graphical user interface profile data for the current user, calculating based on the profile data for the current user, a probability for each of a plurality of volatility targets, each volatility target having the probability influenced by a response from a previous user. The responses from the previous users improve confidence in the volatility target and improves performance of the hardware processor of the intelligent probabilistic volatility server by reducing an amount of processing required for data of lesser statistical relevance. A selected volatility target is assigned to the user profile data for the current user, displayed on the interactive graphical user interface for a first response from the current user, and the first response from the current user is used as dynamic feedback to improve accuracy of the selected volatility target by reinforcing a corresponding probability for the volatility target.

### FIELD OF THE TECHNOLOGY

The embodiments disclosed herein are related to secure intelligent networked architecture with dynamic feedback.

### SUMMARY

Provided herein are exemplary systems and methods for secure intelligent networked architecture with dynamic feedback. Exemplary methods for automatically adapting a volatility target to a current user's preference include an intelligent probabilistic volatility server receiving on an interactive graphical user interface profile data for the current user, calculating for the profile data for the current user, a probability for each of a plurality of volatility targets, each volatility target having the probability influenced by a response from a previous user. The response from the previous user improves confidence in the volatility target and improves performance of the hardware processor of the intelligent probabilistic volatility server by reducing an amount of processing required for data of lesser statistical relevance. A selected volatility target is assigned to the user profile data for the current user, displayed on the interactive graphical user interface for a first response for the current user, and the first response from the current user is used as dynamic feedback to improve accuracy of the selected volatility target by reinforcing a corresponding probability for the volatility target.

In some cases, the profile data for the current user includes any of the current user's risk tolerance, personal information or financial sophistication. Additionally, the previous user's response may indicate the previous user's satisfaction or dissatisfaction with a particular volatility target. The previous user and the current user may also have similar profile data. If the first response from the current user indicates satisfaction with the selected volatility target, an asset having an index matching or close to the selected volatility target will be selected. An asset may be a specific asset, including anything of value, such as equities or a portfolio of assets. If the first response from the current user indicates dissatisfaction with the selected volatility target, another volatility target will be selected for the current user, and an asset having an index matching or close to matching the newly selected volatility target will be selected.

In various exemplary embodiments, at a second time interval, the selected volatility target will be displayed on the interactive graphical user interface for a second response from the current user. The second response from the current user is used as dynamic feedback to improve the accuracy of the selected volatility target by reinforcing a corresponding probability for the selected volatility target.

Further exemplary embodiments include a secure intelligent networked architecture with dynamic feedback including an intelligent probabilistic volatility server having a hardware processor and a memory for storing executable instructions, an interactive graphical user interface communicatively coupled over a network to the intelligent probabilistic volatility server, and a cloud resource communicatively coupled over the network to the intelligent probabilistic volatility server and the interactive graphical user interface. The intelligent probabilistic volatility server is configured to receive from the interactive graphical user interface profile data for the a current user, calculate for the profile data for the current user, a probability for each of a plurality of volatility targets, each volatility target having the probability influenced by a response from a previous user, with the response from the previous user improving confidence in the volatility target and improving performance of the hardware processor of the intelligent probabilistic volatility server by reducing an amount of processing required for data of lesser statistical relevance.

The intelligent probabilistic volatility server may be configured to assign a selected volatility target the to the user profile data for the current user, display the selected volatility target on the interactive graphical user interface for a first response from the current user and use the first response from the current user as dynamic feedback to improve accuracy of the selected volatility target by reinforcing a corresponding probability for the volatility target.

The intelligent probabilistic volatility server may be configured to receive profile data for the current user including any of the current user's risk tolerance, personal information or financial sophistication. It may also be configured to receive a previous user response indicating the previous user's satisfaction or dissatisfaction with a particular volatility target and/or to receive a first response from the current user indicating satisfaction with the selected volatility target. If the intelligent probabilistic volatility server receives the first response from the current user indicating dissatisfaction with the selected volatility target, it will select another volatility target for the current user. It will also select an asset having an index matching or nearly matching volatility to the newly selected volatility target.

In some exemplary embodiments, the intelligent probabilistic volatility server is configured to display at a second time interval the selected volatility target on the interactive graphical user interface for a second response from the current user. It will use the second response from the current user as dynamic feedback to improve accuracy of the selected volatility target by reinforcing a corresponding probability for the selected volatility target.

### BRIEF DESCRIPTION OF THE DRAWINGS

FIG. 1 is a diagram of an exemplary system for secure intelligent networked architecture with dynamic feedback.

FIG. 2 represents a flowchart of an exemplary method for secure intelligent networked architecture with dynamic feedback.

### DETAILED DESCRIPTION OF EXEMPLARY EMBODIMENTS

Provided herein are exemplary systems and methods including the automatic adaptation of a volatility target with a user's preference.

Volatility changes with changing market conditions. Exemplary systems and methods herein include the automatic determination of changes in both volatility and a user's risk profile and implementation of an optimal strategy based on an alignment of both factors. This results in generation of a superior strategy for deployment to real time actual conditions with dynamic feedback to the secure intelligent networked architecture in order for adjustments to be made and the learned generation of superior subsequent strategies.

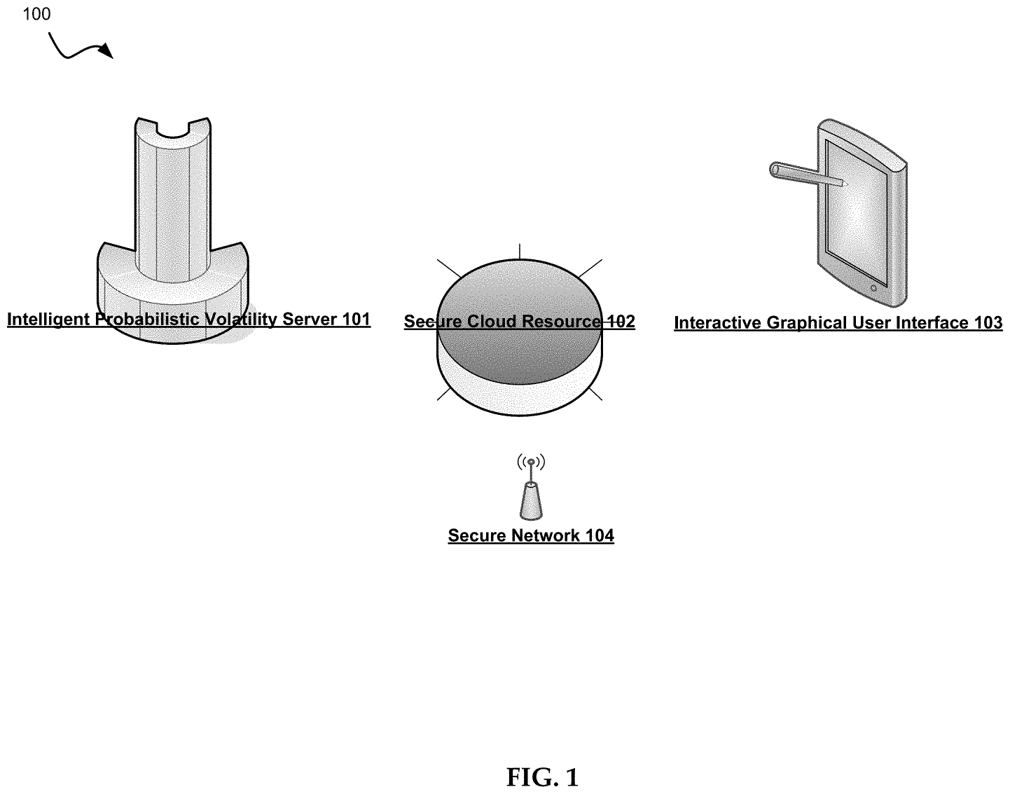

FIG. 1 is a diagram of an exemplary system for secure intelligent networked architecture with dynamic feedback.

The exemplary system 100 as shown in FIG. 1 includes an intelligent probabilistic volatility server 101 having a hardware processor and a memory for storing executable instructions, a secure cloud resource 102, an interactive graphical user interface 103, and a secure network 104.

The intelligent probabilistic volatility server 101 having a hardware processor and a memory for storing executable instructions, according to some exemplary embodiments (although not limited to), is a non-generic computing device comprising non-generic computing components. It may comprise specialized dedicated hardware processors to determine and transmit digital data elements. In further exemplary embodiments, the intelligent probabilistic volatility server 101 comprises a specialized device having circuitry, load balancing, and artificial intelligence, including machine dynamic learning. Numerous determination steps by the intelligent probabilistic volatility server 101 as described herein may be made by an automatic machine determination without human involvement, including being based on a previous outcome or feedback (e.g. an automatic feedback loop) provided by the secure intelligent networked architecture, processing and/or execution as described herein.

The secure cloud resource 102, in some exemplary embodiments, may include specialized servers and/or virtual machines, and receive at least one digital data element from the intelligent probabilistic volatility server 101.

According to various exemplary embodiments, a virtual machine may comprise an emulation of a particular computer system. Virtual machines operate based on the computer architecture and functions of a real or hypothetical computer, and their implementations may involve specialized hardware, software, or a combination of both.

The interactive graphical user interface 103, may include in certain exemplary embodiments, menu selections, icons, condensed information sets and a touchscreen. The interactive graphical user interface 103 may also dynamically display a specific, structured interactive graphical user interface, paired with a prescribed functionality directly related to the interactive graphical user interface's structure.

The secure network 104, in some exemplary embodiments, is any home, business, school, or another network that has security measures in place that help protect it from outside attackers.

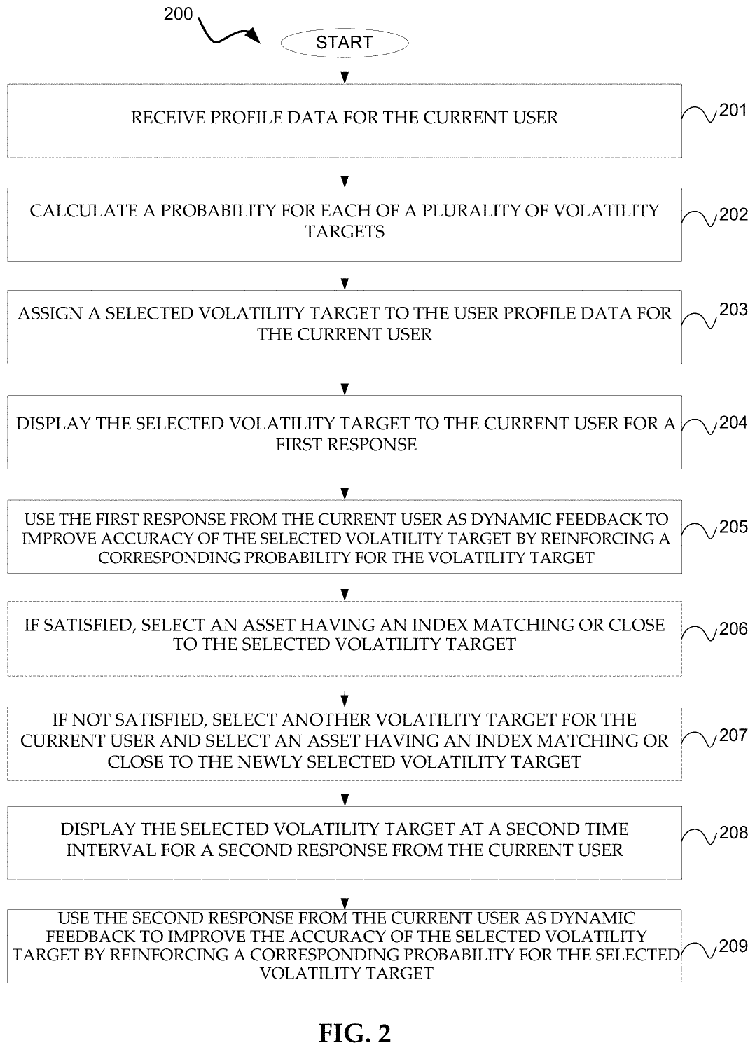

FIG. 2 is a flowchart of an exemplary method 200 for secure intelligent networked architecture with dynamic feedback.

At step 201, exemplary methods for automatically adapting a volatility target to a current user's preference includes an intelligent probabilistic volatility server receiving from an interactive graphical user interface profile data for a current user.

At step 202, the intelligent probabilistic volatility server calculates for the profile data for the current user, a probability for each of a plurality of volatility targets, each volatility target having the probability influenced by a response from a previous user. The responses from the previous users improve confidence in the volatility targets and improves performance of the hardware processor of the intelligent probabilistic volatility server by reducing an amount of processing required for data (e.g. volatility targets) of lesser statistical relevance.

At step 203, the intelligent probabilistic volatility server assigns a selected volatility target to the user profile data for the current user.

At step 204, the intelligent probabilistic volatility server displays the selected volatility target on the interactive graphical user interface for a first response for the current user.

At step 205, the first response from the current user is used as dynamic feedback to the intelligent probabilistic volatility server to improve accuracy of the selected volatility target by reinforcing a corresponding probability for the volatility target.

In some cases, the profile data for the current user includes any of the current user's risk tolerance, personal information or financial sophistication. Additionally, the previous user's response may indicate the previous user's satisfaction or dissatisfaction with a particular volatility target. The previous user and the current user may also have similar profile data.

At optional step 206, if the first response from the current user indicates satisfaction with the selected volatility target, an asset having an index matching or close to the selected volatility target will be selected.

At optional step 207, if the first response from the current user indicates dissatisfaction with the selected volatility target, another volatility target will be selected for the current user. An asset having an index matching or close to the newly selected volatility target will be selected.

At step 208, in various exemplary embodiments, at a second time interval, the selected volatility target will be displayed on the interactive graphical user interface for a second response from the current user.

At step 209, the second response from the current user is used as dynamic feedback to improve the accuracy of the selected volatility target by reinforcing a corresponding probability for the selected volatility target.

In some cases, when an index exhibits greater volatility than a selected volatility target, exposure (e.g. the investment amount in an asset) is reduced. When an index exhibits lower volatility than a selected volatility target, the exposure is increased.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed:

1. A method for automatically adapting a volatility target to a current user's preference comprising an intelligent probabilistic volatility server having a hardware processor and a memory for storing executable instructions, the hardware processor being configured to execute the instructions to perform the method comprising:
receiving on an interactive graphical user interface profile data for the current user;
calculating by the hardware processor for the profile data for the current user, a probability for each of a plurality of volatility targets, each volatility target having the probability influenced by a response from a previous user, the response from the previous user improving confidence in the volatility target and improving performance of the hardware processor of the intelligent probabilistic volatility server by reducing an amount of processing required for data of lesser statistical relevance;
assigning a selected volatility target the to the user profile data for the current user;
displaying the selected volatility target on the interactive graphical user interface for a first response for the current user; and
using the first response from the current user as dynamic feedback to improve accuracy of the selected volatility target by reinforcing a corresponding probability for the volatility target.

2. The method of claim 1, the profile data for the current user further comprising any of the current user's risk tolerance, personal information or financial sophistication.

3. The method of claim 1, the previous user response indicating the previous user's satisfaction or dissatisfaction with a particular volatility target.

4. The method of claim 3, further comprising the previous user and the current user having similar profile data.

5. The method of claim 1, further comprising the first response from the current user indicating satisfaction with the selected volatility target.

6. The method of claim 1, further comprising the first response from the current user indicating dissatisfaction with the selected volatility target.

7. The method of claim 6, further comprising selecting another volatility target for the current user.

8. The method of claim 1, further comprising selecting an asset having an index matching or nearly matching volatility to the selected volatility target.

9. The method of claim 1, further comprising displaying at a second time interval the selected volatility target on the interactive graphical user interface for a second response from the current user.

10. The method of claim 9, further comprising using the second response from the current user as dynamic feedback to improve accuracy of the selected volatility target by reinforcing a corresponding probability for the selected volatility target.

11. A secure intelligent networked architecture with dynamic feedback comprising:
an intelligent probabilistic volatility server having a hardware processor and a memory for storing executable instructions;
an interactive graphical user interface communicatively coupled over a network to the intelligent probabilistic volatility server;
a cloud resource communicatively coupled over the network to the intelligent probabilistic volatility server and the interactive graphical user interface;
the intelligent probabilistic volatility server configured to:
receive from the interactive graphical user interface profile data for a current user;
calculate based on the profile data for the current user, a probability for each of a plurality of volatility targets, each volatility target having the probability influenced by a response from a previous user, the responses from the previous users improving confidence in the volatility targets and improving performance of the hardware processor of the intelligent probabilistic volatility server by reducing an amount of processing required for data of lesser statistical relevance;
assign a selected volatility target the to the user profile data for the current user;
display the selected volatility target on the interactive graphical user interface for a first response from the current user; and
use the first response from the current user as dynamic feedback to improve accuracy of the selected volatility target by reinforcing a corresponding probability for the volatility target.

12. The secure intelligent networked architecture with dynamic feedback of claim 11, the intelligent probabilistic volatility server further configured to:
receive profile data for the current user including any of the current user's risk tolerance, personal information or financial sophistication.

13. The secure intelligent networked architecture with dynamic feedback of claim 11, the intelligent probabilistic volatility server further configured to:
receive the previous user response indicating the previous user's satisfaction or dissatisfaction with a particular volatility target.

14. The secure intelligent networked architecture with dynamic feedback of claim 11, the intelligent probabilistic volatility server further configured to:
receive the first response from the current user indicating satisfaction with the selected volatility target.

15. The secure intelligent networked architecture with dynamic feedback of claim 11, the intelligent probabilistic volatility server further configured to:
receive the first response from the current user indicating dissatisfaction with the selected volatility target.

16. The secure intelligent networked architecture with dynamic feedback of claim 15, the intelligent probabilistic volatility server further configured to:
select another volatility target for the current user.

17. The secure intelligent networked architecture with dynamic feedback of claim 11, the intelligent probabilistic volatility server further configured to:
select an asset having an index matching or nearly matching volatility to the selected volatility target.

18. The secure intelligent networked architecture with dynamic feedback of claim 11, the intelligent probabilistic volatility server further configured to:
display at a second time interval the selected volatility target on the interactive graphical user interface for a second response from the current user.

19. The secure intelligent networked architecture with dynamic feedback of claim 18, the intelligent probabilistic volatility server further configured to:
use the second response from the current user as dynamic feedback to improve accuracy of the selected volatility target by reinforcing a corresponding probability for the selected volatility target.
